(19) United States
(12) Patent Application Publication
(10) Pub. No.: US 2018/0347741 A1
(43) Pub. Date: Dec. 6, 2018

(54) A LAYER OF MINERAL WOOL PROVIDED WITH A SPRAYED-ON PROTECTIVE LAYER

(71) Applicant: Beele Engineering B.V., Aalten (NL)

(72) Inventor: Johannes Alfred BEELE, Aalten (NL)

(21) Appl. No.: 15/778,214

(22) PCT Filed: Nov. 23, 2016
(86) PCT No.: PCT/EP2016/078535

§ 371 Date: May 22, 2018

(30) Foreign Application Priority Data
Nov. 23, 2015 (NL) 1041587

(51) Int. Cl. F16L 59/04; A62C 2/06; F16L 57/04; F16L 59/02; E04B 1/78

(52) U.S. Cl. CPC F16L 59/04; A62C 2/06; B63B 59/00; F16L 59/029; E04B 1/78; F16L 57/04

(57) ABSTRACT

A layer of mineral wool having a first and a second main side (2, 3) which are opposite each other and define a thickness between each other, the layer of mineral wool further having a circumferential side which extends between the first and the second main side, at least a part of the first main side being provided with a sprayed-on protective layer (4) which is non-intumescent and relatively thin in comparison to the layer of mineral wool, the protective layer being adherent to the mineral wool, wherein the protective layer (4) exhibits at atmospheric pressure, during an increase in ambient temperature, a drop in its thermal conductivity.

Thermally insulating materials are important in the building construction industry, for instance to ensure that internally heating the buildings can be carried out efficiently, i.e. without letting too much heat leak out of the building. However, thermally insulating materials are also very important for preventing heat, for instance generated by a fire, to enter a certain compartment or to reach a certain position in a construction. Such insulating materials are particularly important in the ship building and off-shore building industry where the heat of a nearby fire, for as long as possible needs to be prevented from spreading. This may allow a crew and passengers as well as a significant part of a vessel or oil rig, to stay out of a zone of danger. This is particularly relevant in the shipbuilding and off-shore industry as it may take a long time before rescue and evacuation services can be at the scene of the fire accident.

### BACKGROUND

A number of positions in a vessel, or oil rig, or other engineered construction for at least temporarily being located in one of the seas or oceans, are very sensitive to exposure to heat, for instance as originating from a nearby fire. Such sensitive positions may be positions where, on failure of insulation, the fire could rapidly spread throughout the construction. Such positions are often covered by insulating materials, frequently based on mineral wool, also referred to as inorganic fiber based insulation materials. The problem with mineral wool is that the thermal insulation is only available up to a limited elevated temperature. Once the mineral wool is exposed to a high temperature, and/or to flames, the mineral wool may no longer act as thermal insulation and may decompose as a layer, and as such lose its significance. There is a need to provide improved insulation materials based on mineral wool.

### SUMMARY

The present disclosure provides a layer of mineral wool having a first and a second main side which are opposite each other and define a thickness of the layer between each other. The layer of mineral wool further has a circumferential side which extends between the first and the second main side. At least a part of the first main side is provided with a sprayed-on protective layer which is non-intumescent and relatively thin in comparison to the thickness of the layer of mineral wool. The protective layer is adherent to the mineral wool. The protective layer exhibits at atmospheric pressure during an increase in ambient temperature a drop in its thermal conductivity.

Advantageously, the layer of mineral wool is due to the drop in thermal conductivity of the protective layer at some stage during heating up by an increasing ambient temperature protected against the elevated ambient temperature so that it may not deteriorate and not lose its insulating properties. The advantage of the mineral wool, its light weight, easy way of applying the layer of mineral wool against non-flat surfaces, and its low costs, can then over a larger temperature range, and effectively for a longer period of time during exposure to a nearby fire, be maintained.

Further, also advantageously, by providing a protective layer against the mineral wool, the permeability of the mineral wool is reduced, if not fully blocked. The most dominant mechanism for transport of thermal energy through the mineral wool, would normally be by conduction and/or convection of gas. By reducing the permeability, the role of gas is reduced. This forms a major contribution to enhancing the insulation of the mineral wool.

Due to its heat, the gas expands and as such flows in the direction of a decreasing temperature gradient. The protective layer, blocking such a flow from a hot spot outside the mineral wool layer into the mineral wool layer, reduces as such thermal conductivity by convection of gas into and through the mineral wool. One mechanism of heat transport into the mineral wool is thus already frustrated or suppressed by the protective layer.

The protective layer is non-intumescent, i.e. it does not puff up to produce foam. The dimensions and the mechanical properties of the protective layer are therefore not dramatically changed as would otherwise be the case had the protective layer been intumescent.

The feature that the protective layer itself exhibits a drop in its thermal conductivity during an increase in ambient temperature thus, for instance, during exposure to a nearby fire, further limits flow of heat into the mineral wool. Although the temperature gradient over the protective layer may be high, the drop in thermal conductivity dampens a drive to transport heat through the protective layer into the mineral wool layer.

In an embodiment of such a layer of mineral wool, the protective layer has a porous structure and/or forms pores at elevated temperatures. Without wishing to be bound by any theory, it is believed that these pores contribute significantly to a drop in the thermal conductivity of the protective layer, particularly at higher temperatures.

In a material having a porous structure, the thermal conductivity is to an extent determined by conduction of heat by gas. The pores provide many transitions from a pore, i.e. a small cavity (in which heat can be conducted by gas) to a material through which no conduction by gas can occur. A heated molecule can collide with the surface of the material, and as such pass on some of the thermal energy. However, such a collision will largely be elastic, so that the back-bouncing gas molecule will not have passed on much of its thermal energy to the material. As a consequence of this phenomenon, the thermal energy is effectively kept in the gas. The heat is not efficiently transferred through the entire protective layer. This may explain, at least to an extent, the low thermal conductivity of the protective layer.

It is believed that also thermal conductivity by means of radiation (more detailed below) is suppressed in a material having pores. The smaller the pores, the smaller the thermal conductivity by radiation, is presently believed.

A number of different ways of forming a porous structure at elevated temperatures will be mentioned below. A way of forming pores at elevated temperatures could occur by evaporation of liquids out of the protective layer at elevated temperatures, leaving at these higher temperatures empty pores, or cavities, behind. Another way of forming pores takes place naturally during the spraying of the layer of material onto the mineral wool. Further, as discussed below, the type of material and size of its particles may be such that pores are formed.

Preferably, the pores comprise pores having a diameter of less than 700 nanometers. Again, without wishing to be bound by any theory, it is believed that such small pores contribute very significantly to a drop in thermal conductivity of the protective layer, when the ambient temperature rises, for instance, due to a nearby fire. First of all, many small pores would also mean many transitions between a cavity and a material. The heat will predominantly remain within the gas as the transitions do not provide smooth transfers of heat from the gas to the material and vice versa. The transport of the thermal energy will be frustrated.

Preferably, the pores comprise pores having a diameter of less than 70 nanometers. Where the main mechanism for transport of thermal energy is based on conduction of heat by gas, the transport mechanism can also be described as inelastic collisions of a gas molecule having a lot of thermal energy with a gas molecule having less thermal energy. It is thus the number of these collisions that determines to an extent the thermal conductivity of heat through a gas. A parameter related to the number of collisions is the so-called mean-free path of a gas molecule. This is defined as the average distance traveled by a moving gas molecule between successive collisions. The length of this mean-free path is known to increase with the temperature of the gas. If the mean-free path of the gas is longer than the diameter of the cavity in which the heated gas molecule is present, then the gas molecule is more likely to first hit the surface of the material that forms the boundary of the cavity, than with another gas molecule. As explained above, the gas molecule may on colliding with a material pass on some of its thermal energy, but the majority will remain with the gas molecule. For many gas molecules, particularly air molecules (oxygen molecules and nitrogen molecules) the mean-free path at elevated temperatures is higher than 70 nanometers. Collisions between gas molecules are thus rare. A heated gas molecule can hardly pass on energy to another gas molecule. Conduction of heat through the gas phase is now also frustrated. Accordingly, it is believed that heat cannot be swiftly transported through a material comprising many pores having a diameter of less than 70 nanometers, if the predominant mechanism for transport of heat is based on gas conduction.

In an embodiment the protective layer comprises clusterings of particles having a size within the range of 2-300 nanometers. So far consideration is mainly given to heat conduction by gas. However, heat can also be transported through materials. Thus the bit of heat energy passed on to a material during a collision of a gas molecule with that material could possibly “travel” down a temperature gradient in that material. Two mechanisms are known. One mechanism is based on electrons which pass on thermal energy. This is why metals, considered to have many so-called free electrons, are good heat conductors. Another mechanism is based on atoms which pass on thermal energy. It turns out that the more rigid the atomic structure is, and the more pure the structure is, the more likely it is that this mechanism for transport of heat works really well. In support of this view, it is to be noted that a single crystal diamond is one of the best heat conductors (having a very rigid and often pure atomic structure), even though it is electrically insulating (that is, none of the electrons are available for transport of heat through the material).

Advantageously, such a structure comprising clusterings of particles having a size within a range of 2-300 nanometers has more likely many pores. Further, such a structure leads to a material having many impurities in the sense that each boundary of a particle, particularly when placed against the boundary of another particle, forms an irregularity in the structure of the particle. Furthermore, due to the many pores, the material is also not dense, and not rigid. The result is that heat cannot efficiently be passed on from the structure of one particle to the structure of another particle. This does inherently lead to a low thermal conductivity of that material itself, i.e. regardless of the low thermal conductivity of gas in pores that may be present in such a material.

Furthermore, the presence of clusterings of nanoparticles, not only introduces irregularities, there are also “bottlenecks” formed where the particles join. It is believed that such necking between nanometer-sized particles introduces a problem for the heat to be passed on through the materials, based on, effectively, phonon-transport. Such a resistance contributes to a further drop in thermal conductivity of that material itself, i.e. regardless of the low thermal conductivity of gas in pores that may be present in such a material. This contributes to the low thermal conductivity of the protective layer.

In an embodiment, the pores are formed at temperatures in the range of 180-500° C. This has the advantage that although an exposure to elevated ambient temperatures, for instance due to exposure to a nearby fire, the heat would normally start affecting the stability of the mineral wool negatively, the protective layer protects at such temperatures more intensively the mineral wool. Further input of heat into the mineral wool is hindered. A further advantage is that the substance out of which the protective layer is formed, may before application of that substance onto the mineral wool be in a liquid condition, so as to allow for application of the substance onto the mineral wool by means of spraying, or similar techniques. For spraying the substance needs to be in a liquid form as the material needs to be flowable to a nozzle out of which it will be sprayed. The liquid form also allows for introduction of air into the spray, so as to also produce a porous material on settling of the sprayed particles in layer form onto the layer of mineral wool. Including air during spraying may result in air entrapped in cavities in the protective layer.

The formation of pores at temperatures in the range of 180-500° C. may be a result of release of water that at lower temperatures was bound to particles included in the protective layer.

In an embodiment the protective layer comprises opacities for reducing heat transfer by radiation.

Heat transfer by radiation, often referred to as thermal radiation, is electromagnetic radiation generated by the thermal motion of charged particles in matter. The surface of a heated material may emit such radiation through its surface. This is typically Infrared radiation. The rate of heat transfer by radiation is dependent on the temperature of a surface. With an increasing temperature, the heat transfer by radiation increases rapidly. Opacifiers in a material counteract that mechanism, for instance by scattering the radiation, or by absorbing the radiation. An example of an opacifier that scatters radiation is titanium dioxide. An example of an opacifier that absorbs radiation is carbon soot. Transparency of the material tends to become lower when opacifiers are used.

It is further believed that thermal conductivity by means of radiation is suppressed in a material that contains pores. The smaller the pore, the smaller the transfer of thermal energy by radiation.

The protective layer is preferably a fire-retardant layer so that when a fire reaches the layer, it will exhibit low flame-spreading characteristics and exhibit “no-combustion” characteristics. It will sustain in a fire for a significant amount of time.

Preferably the fire-retardant layer is non-combustible in a fire reaching a temperature of up to 1100° C.

Preferably, the protective layer is within the temperature range of 50-1100° C. effectively free from shrinkage. This ensures that the protective layer does not generate cracks and tears and it will thus maintain a continuous layer carrying out its protective function.

Preferably the protective layer is within the temperature range of 50-1100° C. effectively free from thermal expansions. Advantageously, original dimensions can be maintained and no allowances need to be made for expansion upon exposure to heat.

In an embodiment a protective layer has a mineral wool side and an ambience side, wherein the protective layer is impermeable to gas when a pressure difference of 30 mBar is set between the mineral wool side and the ambience side.

Preferably the protective layer is salt water resistant. This is of particular relevance when the mineral wool is provided onboard of a construction that will be out on the sea/ocean. Preferably the resistance to salt water is maintained when the protective layer has been exposed to a fire. This ensures that even when a fire has occurred there is no need to replace the mineral wool and the protective layer for reasons that it would no longer be resistant to salt water.

In an embodiment, the sprayed-on protective layer is a layer formed by spraying a water-based polymer emulsion onto the mineral wool.

In an embodiment also at least a part of the second main side of the mineral wool layer is provided with the sprayed-on protective layer. In an embodiment, also at least a part of the circumferential side of the mineral wool layer is provided with the sprayed-on protective layer. Particularly when the entire mineral wool layer, that is all sides of the mineral wool layer, are covered by the protective layer, and the protective layer does fully enclose the mineral wool layer, any shrinkage of the mineral wool during exposure to heat, will not affect the overall dimension of the combination of the mineral wool and the protective layer. This has advantages for situations where the mineral wool is provided in the shape of plates or blocks for constructions where their original dimensions need to be maintained.

The invention also relates to a sprayable water-based polymer emulsion suitable for forming by spraying onto a mineral wool layer a protective layer for forming a mineral wool layer according to any of the embodiments discussed above.

The present disclosure is further based on a drawing, in which:

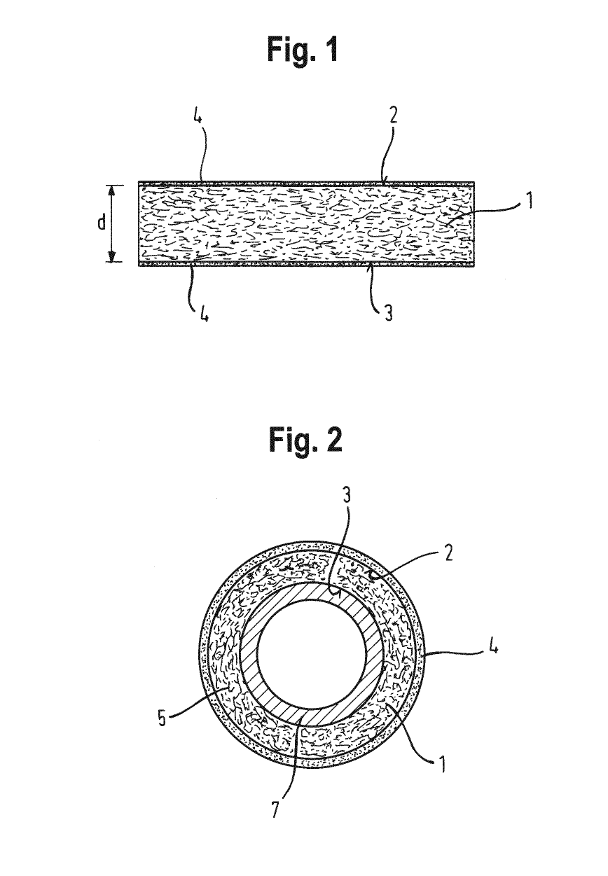

FIG. 1 shows schematically in cross-section an embodiment of the present disclosure;

FIG. 2 shows schematically in cross-section an embodiment of the present disclosure;

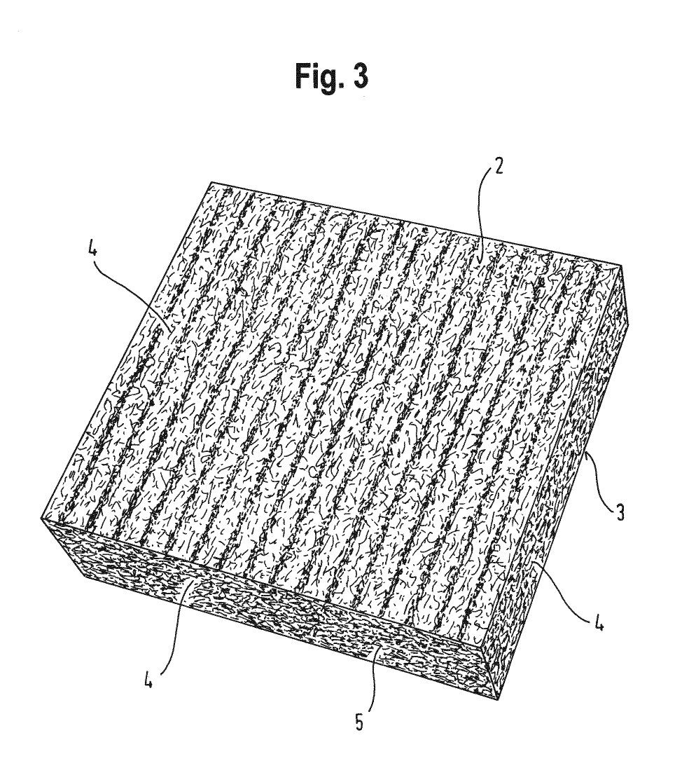

FIG. 3 shows in a perspective view an embodiment of the present disclosure;

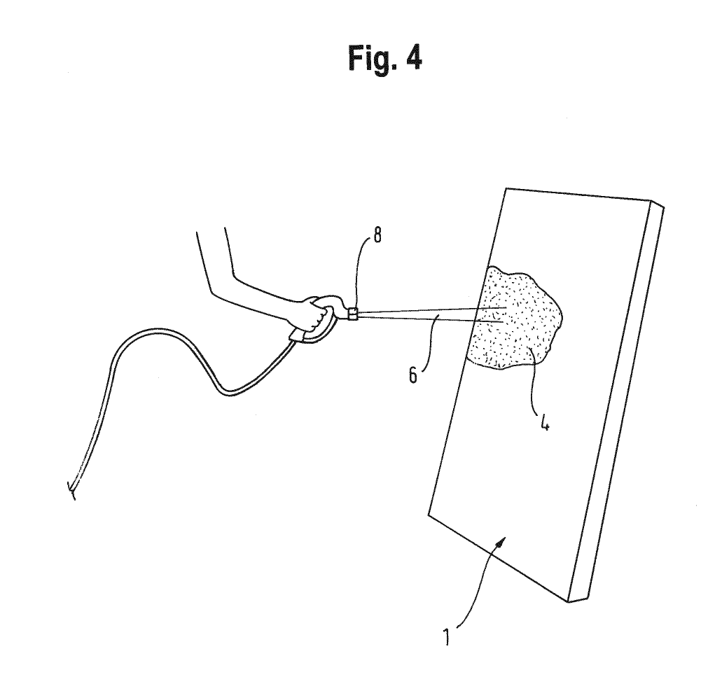

FIG. 4 shows schematically a way of producing an embodiment of the present disclosure.

In the description of the drawing, like parts have like references.

FIG. 1 shows a cross-section of a layer of mineral wool 1 having a first and a second main side 2, 3 which are opposite each other and define a thickness d between each other. The layer of mineral wool 1 has a circumferential side which is not shown in FIG. 1 but which would normally extend between the first and second main side 2, 3. See for example FIGS. 2 and 3. The first main side 2 is provided with a sprayed-on protective layer 4 which is non-intumescent and relatively thin in comparison to the layer of mineral wool 1. The protective layer 4 is adherent to the mineral wool. The protective layer 4 exhibits at atmospheric pressure during an increase in ambient temperature, a drop in its thermal conductivity. In the example shown in FIG. 1, also the second main side 3 of the layer of mineral wool 1 is provided with such a protective layer 4. In the example of FIG. 2, where the layer of mineral wool 1 is applied around a pipe 7, only one main side is provided with the protective layer.

The ambient temperature is the air temperature of the environment in which the mineral wool layer 1 is kept.

The protective layer 4 is non-intumescent, meaning that it does not puff up to form a foam when the temperature of the layer increases. The protective layer 4 can be provided by applying the so-called “FISSIC coating”, as commercially available from the Applicant (www.fissiccoating.com). The spayed-on layer can then be formed by spraying such a water-based polymer emulsion 6 onto the mineral wool layer 1.

The protective layer 4 has a porous structure and/or forms pores at elevated temperatures. A porous structure may be present in the particles which at least partly make up the protective layer but may also be formed at elevated temperatures, for instance by release of bonded water out of the protective layer. Pores may also have been formed by the way the protective layer is applied, i.e. by entrapping air into the layer during spraying of the water-based polymer emulsion onto the mineral wool 1. The pores may comprise pores having diameters of less than 700 nanometers. Preferably the pores comprise also pores having a diameter of less than 70 nanometers. The pore structure may comprise clusterings of particles having a size within the range of 2-300 nanometers. It is possible that a number of the pores are formed at temperatures in the range of 180-500° C. The density of the protective layer may thus be varied, depending on the number and density of the pores.

The protective layer may comprise opacities for reducing heat transfer by radiation. Opacities are known in the art, a typical example is titanium dioxide. Another typical example is carbon soot.

The protective layer 4 is preferably a fire-retardant layer.

To this end, highly suitably, borates conventionally used as fire retardants; plasticizers of the organic phosphate type such as trialkyl phosphates and triaryl phosphates, and in particular trioctylphosphate, triphenylphosphate and diphenyl cresyl phosphate; solid fire retardants such as ammonium polyphosphate, for instance Antiblaze MCO: and melamine polyphosphate (melapur 200) can be used.

The fire retardant layer is preferably non-combustible in a fire reaching a temperature up to 1100° C. The protective layer 4 is within a temperature range of 50-1100° C. effectively free from shrinkage and, preferably, free from thermal expansion. The protective layer 4 is salt water resistant, preferably even after fire. Reference is made to KIWA Netherlands report 20150421 HN/01 for the performance of the so-called “FISSIC coating” in this respect. The protective layer 4 is impermeable to water and/or impermeable to gas (at least when the gas pressure difference is 30 mBar).

FIG. 2 shows an embodiment where the layer of mineral wool 1 is wrapped around a pipe 7, which could be a pipe of any sort and of any type of material. The protective layer 4 is sprayed on after wrapping the layer of mineral wool 1 around the pipe 7.

FIG. 3 shows an embodiment of a layer of mineral wool of which each side is provided with a protective layer 4.

FIG. 4 shows schematically how the protective layer 4 can be provided by spraying the water-based polymer emulsion 6 out of a nozzle 8 onto the layer of mineral wool 1.

Layers of mineral wool are widely commercially available, as can easily be assessed by searching for suppliers of mineral wool in the Internet. A sprayable emulsion suitable for spraying onto a mineral wool layer a protective layer for forming a mineral wool layer according to the present disclosure is on the day of this disclosure also available, at least via the website www.fissiccoating.com

Many applications, each making use of embodiments of the present disclosure, are easily conceivable. Not only in a maritime climate/environment but also in the building industry use can be made of embodiments of this disclosure.

1. A layer of mineral wool having a first and a second main side which are opposite each other and define a thickness between each other, the layer of mineral wool further having a circumferential side which extends between the first and the second main side, at least a part of the first main side being provided with a sprayed-on protective layer which is non-intumescent and relatively thin in comparison to the layer of mineral wool, the protective layer being adherent to the mineral wool, wherein the protective layer exhibits at atmospheric pressure during an increase in ambient temperature, a drop in its thermal conductivity.

2. A layer of mineral wool according to any one of the previous claims, wherein the protective layer has a porous structure and/or forms pores at elevated temperatures.

3. A layer of mineral wool according to claim 2, wherein the pores comprise pores having a diameter of less than 700 nanometers, and preferably less than 70 nanometers.

4. A layer of mineral wool according to any one of the previous claims, wherein the porous structure comprises clusterings of particles having a size within a range of 2 to 300 nanometers.

5. A layer of mineral wool according to any one of claims 2-4, wherein at least a number of the pores are formed at temperatures in the range of 180 to 500° C.

6. A layer of mineral wool according to any one of the previous claims, wherein the protective layer comprises opacities for reducing heat transfer by radiation.

7. A layer of mineral wool according to any one of the previous claims, wherein the protective layer is a fire retardant layer.

8. A layer of mineral wool according to claim 7, wherein the fire retardant layer is non-combustable in a fire reaching a temperature up to 1100° C.

9. A layer of mineral wool according to anyone of the previous claims, wherein the protective layer is within a temperature range of 50-1100° C. effectively free from shrinkage.

10. A layer of mineral wool according to any one of the previous claims, wherein the protective layer is within a temperature range of 50-1100° C. effectively free from thermal expansion.

11. A layer of mineral wool according to any one of the previous claims, wherein the sprayed-on protective layer is a layer formed by spraying a water based polymer emulsion onto the mineral wool.

12. A layer of mineral wool according to any one of the previous claims, wherein the protective layer is salt water resistant.

13. A layer of mineral wool according to any one of the previous claims, wherein the protective layer is impermeable to water and/or impermeable to gas.

14. A layer of mineral wool according to any one of the previous claims, wherein also at least a part of the second main side is provided with the sprayed-on protective layer.

15. A layer of mineral wool according to any one of the previous claims, wherein also at least a part of the circumferential side is provided with the sprayed-on protective layer.

16. A sprayable emulsion suitable for forming by spraying onto a mineral wool layer a protective layer for forming a mineral wool layer according any one of claims 1-15.
